(19) United States
(12) Patent Application Publication
(10) Pub. No.: US 2015/0294426 A1
(43) Pub. Date: Oct. 15, 2015

(54) CASE MANAGEMENT USING ACTIVE ENTITIES IN A SOCIAL NETWORK

(71) Applicant: HEWLETT-PACKARD DEVELOPMENT COMPANY, L.P., Houston, TX (US)

(72) Inventors: Hamid Reza Motahari Nezhad, Palo Alto, CA (US); Sven Graupner, Palo Alto, CA (US); Susan Deborah Spence, Palo Alto, CA (US); Claudio Bartolini, Palo Alto, CA (US)

(21) Appl. No.: 14/439,832

(22) PCT Filed: Oct. 31, 2012
(86) PCT No.: PCT/US2012/062677

§ 371 Date: Apr. 30, 2015

(51) Int. Cl. G06Q 50/00; G06Q 10/00

(52) U.S. Cl. CPC G06Q 50/01; G06Q 10/00

(57) ABSTRACT

Entities of a case are provided as active entities in a social network. As part of managing the case, a first of the active entities can interact with a second of the active entities using the social network.

### BACKGROUND

Personnel of an enterprise (e.g. business concern, government organization, educational organization, etc.) can perform various different activities, such as information technology activities, sales activities, legal activities, product or service development activities, and so forth. The activities can be managed as cases. Case management can involve a mix of automated work and human work.

The activities of a case can include tasks and processes, where each process includes a corresponding collection of inter-related tasks. Personnel at an enterprise may manage a relatively large amount of cases. As the volume of cases and the complexity of cases increase, traditional techniques and systems for case management are often inefficient.

### BRIEF DESCRIPTION OF THE DRAWINGS

Some embodiments are described with respect to the following figures:

FIG. 1 is a flow diagram of a case management process according to some implementations;

FIG. 2 is a block diagram of an example arrangement of components for performing case management in accordance with some implementations;

FIG. 3 is a graph depicting a case management data model in accordance with some implementations;

FIG. 4 is a flow diagram of a case management process according to further implementations; and

FIG. 5 is a block diagram of a system that is capable of performing social networking case management according to some implementations.

### DETAILED DESCRIPTION

A case can include information relating to various entities that allow work to be performed to achieve a respective goal. In some implementations, a case can include artifacts, tasks, processes that contain inter-related tasks, and other entities. More generally, a case can be a container of information related to handling an engagement (e.g. an engagement relating to sales of a product or service, an engagement relating to patient care, etc.). Managing a case can involve both human work and automated work.

Traditionally, case management is based on performing work of a case by humans and systems that may be isolated from one another. Additionally, the status of a case may be tracked manually. As a result, traditional case management techniques can be relatively inefficient and inflexible.

To provide more efficient and flexible case management techniques and systems, a social networking framework can be employed for case management. Such a framework can be referred to as a case management social networking framework. In the social networking framework, various entities associated with a case can be provided as active entities that are able to interact with each other and with one or multiple actors (humans or automated systems) through a social network. A “social network” can refer to an information sharing system that allows for participants (including the active entities, humans, and/or automated systems) to exchange information with each other. A social network can be implemented within an enterprise, such as a business concern, educational organization, government organization, and so forth. Alternatively, a social network can be provided across multiple enterprises, or alternatively, a social network can be a public social network that is more widely available to users. In accordance with some implementations, a social network can be configured to become a productivity tool that can aid in getting work done by users.

As noted above, the different types of entities that can be associated with a case can include a process, a task, and an artifact. The case itself can also be considered an entity in a case management social networking framework. In some implementations, cases, processes, tasks, and artifacts are considered first class entities in the social network. First class entities are entities that are peers of each other—in other words, the entities can interact with each other. As noted above, the entities (including a case, a process, a task, and an artifact) are active entities, where an active entity is an entity that can receive and emit events, and that can be connected to actors of the social network to allow for interaction between the active entities and the actors. Events received and emitted by an active entity can include various information, including information regarding status updates, information regarding state changes of an active entity, and other information.

The active entities used in the case management social networking framework according to some implementations can provide at least some of the following. A status update provided by a first active entity can trigger a notification of the status update to one or multiple other active entities. In addition, an automated technique is provided to identify one or multiple active entities that may be affected as a result of a state change in a case—for example, information relating to the state change of the case can be propagated to interested active entities. A state change of a case can also trigger predefined action(s), which can be defined in a case template or by an ad-hoc rule specified by an actor. An example type of an ad-hoc rule can be an event-condition-action rule where an event triggers the action if the condition is met. A case may have one or multiple event-condition-action rules, which can be defined in an ad hoc manner by case actors to allow for personalized management of cases beyond predetermined generic rules. A case can have one or multiple followers, who can receive updates from the case.

In some implementations, reference is made to a case that includes processes, tasks, and artifacts. In other implementations, a case can include alternative entities. For example, a case can include information elements, a roadmap, and a process. Information elements can include attributes of the case and artifacts (documents). A roadmap (which is also an active entity) includes checkpoints (which can be considered milestones or synchronization points) and decision points (points at which decisions can be made). A case manager can define the set of information elements that are to be used at the checkpoint or decision point. A process can include tasks (also referred to as collaborative tasks) and meeting nodes (also referred to as conversational tasks where conversations between active entities and/or actors can occur), a graph that captures the interdependencies of the tasks and meeting nodes. A task can take information elements as input, and produce information elements or a result of decision-making as output. A roadmap and a process can be related. For example, before or after each checkpoint or decision point, a sub-process (a graph of tasks and/or meeting nodes) may be defined or executed. The process and roadmap do not have to be defined prior to execution. The process and roadmap definitions and their execution can occur simultaneously and be updated as the execution proceeds. A checkpoint, decision point, or meeting node is a subtype of a task; in other words, checkpoints, decision points and meeting nodes can be generalized as tasks in a case management social networking framework.

Various example entities, including a case, a process, a task, and an artifact, are further described below.

An artifact can refer to a document, an input form, a media item, or other item on which a task of a case can be performed. The artifact can include rich content, including video data, audio data, image data, text data, and so forth. An artifact can be considered to be an instance of an artifact template that provides a profile describing the artifact that is to be used as part of a best practices guideline for the management of a given case. An artifact template can be associated with an owner (who has authority to edit the artifact template). An artifact template can define multiple versions of the corresponding artifact. An artifact can be an input to or an output from a task or process.

A task can refer to an activity that is to be performed in a case. A task can have a profile (or template), an owner, a set of attributes (including a state attribute that represents the state of the task), and a set of associated roles. Having a profile allows the task to be followed by social network actors (users or automated systems). At execution time, a task instance is instantiated from a task.

Examples of a state of a task can include the following: ready (indicating that the task is ready to be executed), assigned (indicating that the task has been assigned to an actor), pending (indicating that the task is waiting to be executed or is currently being executed), and completed (indicating that the task has completed). In other examples, a task can have other states. The owner of a task is an actor in the social network who has the authority to edit the task. A task can also have subtasks. A task can also be associated with one or multiple artifacts that can be input into or output from the task.

In some examples, a role that can be associated with a task can include any of the following: Accountable/Approver, Responsible, Follower. A role of a task is assigned to a respective actor. For example, an actor assigned the Accountable/Approver role is an actor who is accountable for completion of the task, and may be an actor who has to approve the task before the task is declared complete. An actor assigned the Responsible role may be an actor who performs the task. An actor assigned the Follower role is an actor who is interested in being informed of a status of the task as the task executes in the case.

A process can have a profile (or template), and is composed of a set of tasks that are inter-related. The process can be represented by a task precedence graph, which shows relationships among the tasks of the process (e.g. a first task is performed prior to other tasks, where the first task produces an output that is used by the other tasks). The process can also have a set of one or multiple artifacts that constitute the input to or output from the process. In some implementations, the processes can be best practice processes to be provided by the case management social networking framework. A best practice process can refer to a process that is considered by an enterprise or user to conform to a target guideline with respect to performing work associated with a case.

In some implementations, a case includes a process as a collection of inter-related tasks that are performed to achieve a certain goal, such as to achieve a sales goal, to handle a service engagement, and so forth. A case is associated with one or multiple process profiles that are enacted during the course of case management. Each process profile associated with the case identifies a process that is to be performed in the case. In other implementations, a case includes a roadmap (including checkpoints and decision points) and a process as a collection of inter-related tasks (collaborative or conversational) that are performed to achieve a certain goal. In the latter implementations, a case is associated with one or multiple roadmap profiles that describe key checkpoints and decision points, and process profiles that are enacted during the course of case management.

A case can also be associated with one or multiple actors that are involved in the case. Each actor can be assigned one of a number of roles in the case. One role is a case manager, who is ultimately accountable for the case. Other example roles can also be defined for actors involved in the case.

More generally, an actor can refer to a user or automated system in the social network that can take on a role in the case or with respect to a task (as discussed above). An active entity (e.g. case, roadmap, process, task, or artifact) can interact with the actor in the case management social networking framework.

The profile (or template) of a roadmap, process, task, or artifact can specify that the roadmap, process, task, or artifact subscribes to a particular case that uses the roadmap, process, task, or artifact. The subscribing roadmap, process, task, or artifact can be informed about a change made to the process, task, or artifact during case enactment (performance of the case). The information regarding the change provides the subscribing entity (and actors) insight regarding how the respective entity (process, task, or artifact) is being used during case enactment. Such information can be used to modify subsequent behavior of the roadmap, process, task, or artifact.

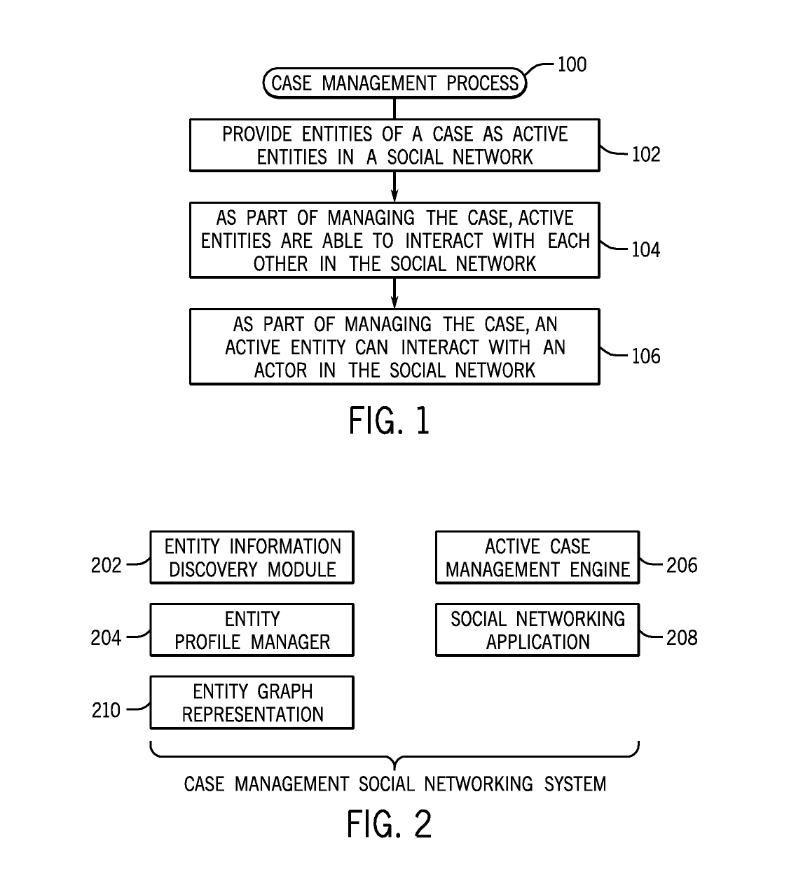

FIG. 1 is a flow diagram of a case management process 100 according to some implementations. The case management process 100 provides (at 102) entities of a case as active entities in a social network. An active entity in the social network is capable of interacting with another active entity in the social network. As part of managing the case, the active entities are able to interact (at 104) with each other in the social network (such as one active entity providing a status update to another active entity). In addition, as part of managing the case, an active entity can interact (at 106) with at least one actor in the social network. For example, a task can seek approval from an actor prior to indicating the task as complete. A task can also provide a status update to an actor.

FIG. 2 illustrates an example system for providing a case management social networking framework according to some implementations. The system depicted in FIG. 2 can perform various functionalities such as those depicted in FIG. 1 and other functionalities. An entity information discovery module 202 is able to discover information associated with various case entities, including a case, one or multiple roadmaps and processes in the case, tasks associated with the process(es) in the case, and associated artifacts that are inputs into and outputs from the process(es) and tasks.

A case entity profile manager 204 collects usage information of the active entities associated with the case. The case entity profile manager 204 can relate the collected usage information to corresponding profiles of the active entities associated with the case. The collected usage information can be stored in association with the profiles.

An active case management engine 206 provides a publish-subscribe arrangement. With the publish-subscribe arrangement, a subscribing active entity can subscribe to information pertaining to a publishing active entity (in other words, the subscribing active entity has subscribed to receive notification from the publishing active entity). Upon detecting status changes to the publishing active entity, the active case management engine 206 is able to propagate the status changes to the subscribing active entity. The active case management engine 206 can also offer flexibility features for case management in the social networking framework, as discussed further below.

The system of FIG. 2 also includes a social networking application 208 that provides the social networking framework to allow for participants (active entities associated with a case, and actors) to interact with each other through a social network. As an example, the social networking application 208 can be the WaterCooler application from the Hewlett Packard Co. In other examples, other types of social networking applications can be employed.

The system of FIG. 2 also includes an entity graph representation 210, which can include one or multiple task precedence graphs associated with the process(es) of a case, or the case roadmap. As noted above, a task precedence graph shows relationships among the tasks of a process and/or a roadmap.

As noted above, the active case management engine 206 can also offer flexibility features for case management. Such flexibility features can include skipping tasks, jumping to tasks, repeating tasks, adding tasks, or otherwise modifying performance of tasks in the case from a previously determined arrangement of task performance. In this manner, adaptive task orders can be provided, based on a particular context of a case during enactment of the case. The context of a case can include indications of what events have occurred and what conditions have been met or violated.

Skipping tasks and jumping to tasks allow the order of tasks to be changed, so long as dependencies among tasks with respect to the inputs and outputs of the tasks are satisfied. Moreover, certain tasks can be marked as being mandatory tasks, while other tasks can conditionally be performed based on evaluation of whether certain conditions are met.

A further flexibility feature can include the ability to execute an un-enabled task. In a case, only tasks for which dependencies have been satisfied are executed. Such tasks are referred to as enabled tasks. In some cases, an actor can manually decide to execute an un-enabled task.

Upon repeating the execution of a task that has already completed, the status of the task can be rolled back from “completed” to “in-progress.” In some examples, a record of a previous execution of the task and the input and output artifacts of the task can be maintained. Re-execution of the task can trigger notifications to alert actors regarding other tasks that depend on the modified outputs due to task re-execution.

The ability to add a task to a case allows further activity to be added to the case in an ad-hoc manner. The added task can be based on an existing task profile, or alternatively, the added task can be custom-defined.

An additional flexibility feature provided by the active case management engine 206 is that different instances of a task can be configured differently (based on modifying parameters associated with each task instance). This provides adaptive tasks that can adapt to a context of a case.

Further flexibility features provided by the active case management engine 206 can include the ability to modify configurable parameters in a roadmap profile or process profile. Examples of configurable parameters can include the size of a sales deal, a geographic region, and so forth. The parameters of a process can be updated as a case progresses.

A further flexibility feature that can be provided is the ability to add a process profile to a case. Adding a process profile to a case causes the collection of tasks of the corresponding process to be added to the planned tasks of the case.

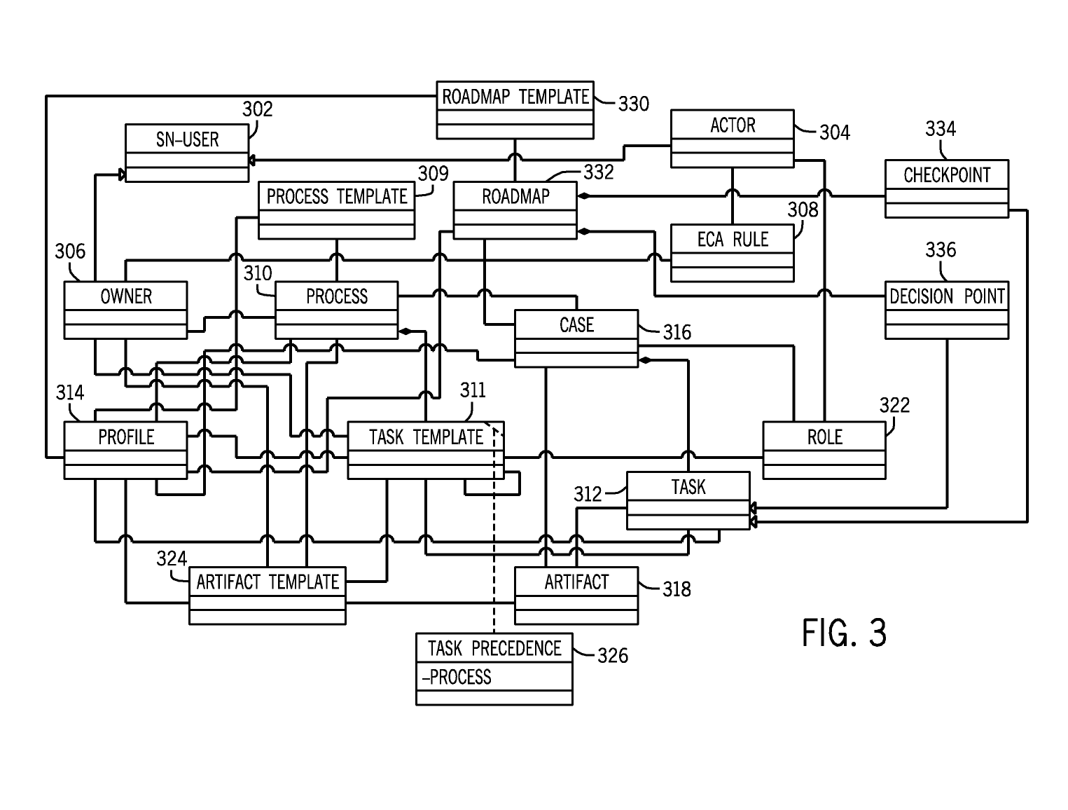

FIG. 3 shows a case management data model that represents relationships between various participants of the case management social networking framework according to some implementations. The case management data model includes various nodes that are linked by edges. The nodes represent potential participants of the case management social networking framework. Although a specific relationship among the subscribers is shown in FIG. 3, note that in other implementations, other types of relationships may exist.

A node 302 represents a social network user. According to the model of FIG. 3, an actor (represented by node 304) is one type of social network user, while an owner (represented by node 306) is another type of social network user. An actor (represented by node 304) can define an event-condition-action (ECA) rule, which is represented by node 308.

A node 310 represents a process, which is associated with a process template represented by node 309. The process represented by node 310 is composed of a task (or multiple tasks) corresponding to a task template (or task templates) represented by node 311. An instance of the task template 311 is a task represented by node 312. A node 326 represents task precedence, which specifies an order of tasks represented by the task template node 312.

The process represented by node 310 can be associated with a case, which is represented by node 316. A case represented by node 316 also can be associated with an artifact that is represented by node 318. A case represented by node 316 is composed of a task represented by node 312.

An actor (represented by node 304) can be assigned a role, as represented by node 322. The role can be associated with a task template represented by node 311.

An artifact represented by node 318 is associated with an artifact template (which is represented by node 324). The artifact template can be associated with a process represented by node 310 and a task template represented by node 311, where the artifact template corresponds to an artifact that can be an input to or output from the process or task.

The model of FIG. 3 also includes a roadmap template (represented by node 330), which defines a roadmap (represented by node 332). The roadmap includes a checkpoint (represented by node 334) and a decision point (represented by node 336). Outputs of the checkpoint and decision point are provided to a task represented by node 312.

A profile represented by node 314 is associated with each of a process template (node 309), process (node 310), task template (node 311), case (node 316), task (node 312), artifact template (node 324), roadmap template (node 330), and roadmap (node 332). Such links indicate that each of a process template, process, task template, task, case, artifact template, roadmap template, and roadmap is associated with a profile.

As noted above, a particular active entity can subscribe to obtain information regarding a change made to a profile of the particular active entity during enactment of a given case. This information regarding the change can be stored as part of the profile, or in association with the profile, to allow the system to modify subsequent behavior relating to the particular active entity.

An owner represented by node 306 is associated with each of an ECA rule (node 308), process (node 310), artifact template (node 324), and task template (node 311).

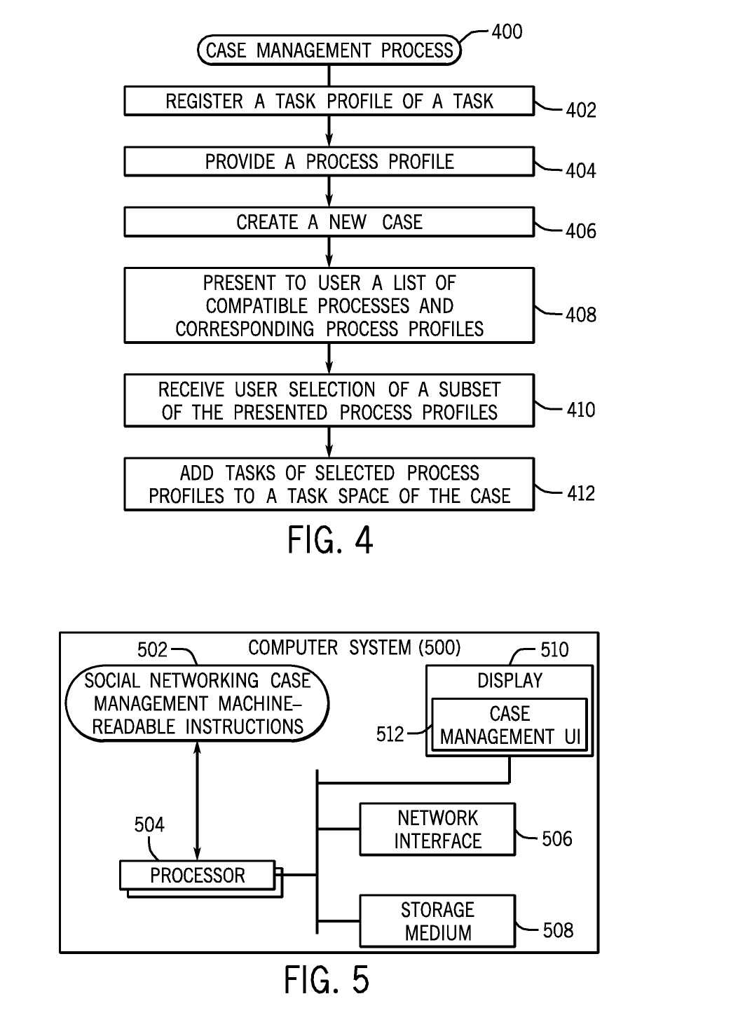

FIG. 4 depicts a case management process 400 according to further implementations. The case management process 400 can be performed by the various modules of the system depicted in FIG. 2, for example.

The case management process 400 can register (at 402) a task profile in the case management social networking framework. A task represented by the task profile is potentially reusable across several processes. The task profile can include a description of how the task is to be performed, the roles that are involved in the task, input and output artifacts, task variances (based on configurable parameters such as geography and sales region), and a list of supporting resources.

The case management process 400 also provides (at 404) a process profile that includes a description, a list of tasks, and the precedence of tasks which can be represented as a dependency graph.

The case management process 400 can also create (at 406) a new case in the case management social networking framework. As part of creating the new case, a case manager may choose a number of configuration parameters for the case, which can be input by the case manager into the system. In a product sales context, for example, the configurable parameters can include: region, industry, size of the deal, and deal type.

Based on the received configuration parameters, the case management process 400 presents (at 408) a list of compatible processes and a corresponding set of process profiles to the user. The user may select a subset of the presented process profiles in the case. The user selection of the subset of process profiles is received (at 410) by the case management process 400.

The case management process 400 adds (at 412) tasks associated with the selected processes to a task space of the created case, using each process as a way to group tasks. Note that tasks in the task space of the case may have dependencies (based on their input/output), which can be automatically established by the active case management engine 206. The user may also define additional precedence constraints on the tasks.

Although not depicted in FIG. 4, it is noted that the case management process 400 can also provide a roadmap profile that includes checkpoint(s) and decision point(s) as discussed above.

Note that creating a case and executing the case can be interleaved. In other words, the case can be executed while elements of the case are still being defined.

The following describes examples of various interactions that can be performed between a social network user and active entities of a case.

A social network user viewing a case profile in the case management social networking framework can interact with the case profile in various ways. The social network user can explore the description and composition of the case to see what best practice guidelines the case enacts, for what purpose and which process profiles the case uses. The social network user can view a current status of the case to see what task is currently being enacted, and view the artifacts that have been input to this task or are under preparation as outputs.

In addition, the social network user can see who are the active participants (the actors) working on the case and who are the followers who are interested in this case. The social network user can designate himself or herself as a follower on the case.

Furthermore, the social network user can submit a comment on the case, uninitiated or as part of an ongoing discussion that will now become part of the case history.

A social network user who is an actor with an active role in a case can also view a list of past and current activities of the case, tailored to the user's role. The social network user can follow links from the case profile to view and navigate the relationships that contribute to the composition of the case. The social network user can also view and change the composition of the case, such as by skipping a task from one of the process profiles. The social network user can also submit an artifact as an output artifact of a task.

When social network users interact with entities in the case management social network, data is generated that either records the usage of those entities or adds to the history and knowledge about their usage. This data enables someone composing a new case using an existing process profile to learn from previous experience by reviewing the changes made to instances of that process during past case enactments. Users can compare the task composition of previous enactments of a process, and task additions and removals (skips) can be highlighted. Users may review comments submitted when the task was skipped to determine whether the same factors apply in their own circumstances. This enables future users of a process to make more well-informed decisions on the composition of their own cases. They may, for example, decide to keep the task and add a comment to the process template saying why the task is still desirable in some cases. In this way, process profiles can evolve over time, with accompanying valuable statistics and informed opinions on their usage.

FIG. 5 depicts a computer system 500 that can incorporate some implementations. The computer system 500 can be implemented with one computer or a distributed arrangement of computers. The computer system 500 includes social networking case management machine-readable instructions 502, which can implement the various modules depicted in FIG. 2, for example.

The social networking case management machine-readable instructions 502 are executable on one or multiple processors 504, which can be connected to a network interface 506 (to allow the computer system 500 to communicate over a network. The processor(s) 504 can also be connected to a computer-readable or machine-readable storage medium (or storage media) 508. A processor can include a microprocessor, microcontroller, processor module or subsystem, programmable integrated circuit, programmable gate array, or another control or computing device.

The computer system also includes a display device 510, which can display a case management user interface 512 associated with the case management social networking framework. The case management user interface 512 allows a user to interact with the active entities of the case management social networking framework, such as through the social networking application 208 of FIG. 2.

Storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
providing, by a system having a processor, entities of a case as active entities in a social network, the active entities including tasks and an artifact, and the active entities to emit and receive information of the case;
as part of managing the case, a first of the active entities interacting with a second of the active entities using the social network; and
as part of managing the case, at least one of the active entities interacting with at least one actor in the social network.

2. The method of claim 1, further comprising:
subscribing, by a particular one of the active entities, to the case; and
receiving, by the particular active entity, notification of a change made to a profile of the particular active entity as part of enacting the case.

3. The method of claim 1, further comprising:
in response to an update of a first one of the active entities, sending a notification to a second one of the active entities through the social network.

4. The method of claim 1, wherein the active entities further include a process that contains a set of inter-related tasks, the method further comprising:
associating a profile of the process with the case.

5. The method of claim 4, further comprising:
adding a second profile of a second process to the case, wherein adding the second profile causes tasks of the second process to be added to a collection of planned tasks to be performed for the case.

6. The method of claim 4, further comprising:
providing a case management engine to support at least one flexibility feature selected from among: adding a task to the case, skipping a task in the case, re-execute a task in the case, changing an order of performing tasks, and configuring at least one parameter of a profile of the process or the task.

7. The method of claim 1, wherein the active entities further include a roadmap that contains a checkpoint and a decision point, the method further comprising:
associating a profile of the roadmap with the case.

8. The method of claim 1, further comprising:
providing a case management engine to adapt the tasks to a context of the case, and to adapt an order of the tasks based on the context.

9. The method of claim 1, further comprising:
providing an event-based rule that defines an event that triggers an action to take if a condition is satisfied.

10. An article comprising at least one machine-readable storage medium storing instructions that upon execution cause a system to:
provide a task profile of a task that is reusable across a plurality of processes in a case management framework that includes a social network;
provide a process profile for at least one of the processes, the process including a plurality of inter-related tasks;
create a case and receive configuration parameters relating to the case;
present respective process profiles of at least a subset of the processes based on the received configuration parameters; and
receive selection from among the presented process profiles for use in the case, wherein a task and a profile of the case are active entities that are to interact through the social network.

11. The article of claim 10, wherein the instructions upon execution cause the system to further:
cause at least one of the active entities to interact with an actor in the social network.

12. The article of claim 10, wherein the instructions upon execution cause the system to further:
provide an artifact as an active entity in the case, the artifact being an input into or an output from a task or a process.

13. The article of claim 10, wherein the interaction between the active entities includes a first active entity providing a status update of the first active entity to a second active entity that has subscribed to receive notification from the first active entity.

14. The article of claim 10, wherein the instructions upon execution cause the system to further:
modify an order in execution of tasks of the case based on the context of the case.

15. A system comprising:
at least one processor to:
provide entities of a case as active entities in a social network, the active entities including tasks and an artifact, and the active entities to emit and receive information of the case;
as part of managing the case, cause a first of the active entities to interact with a second of the active entities using the social network; and
as part of managing the case, cause at least one of the active entities to interact with at least one actor in the social network.
